(19) United States
(12) Patent Application Publication
(10) Pub. No.: US 2006/0015246 A1
(43) Pub. Date: Jan. 19, 2006

(54) Method and apparatus for specifying destination using previous destinations stored in navigation system

(76) Inventor: Alvin Hui, Redondo Beach, CA (US)

Correspondence Address: MURAMATSU & ASSOCIATES;Suite 310, 114 Pacifica, Irvine, CA, 92618, US

(21) Appl. No.: 10/891,560

(22) Filed: Jul. 15, 2004

(51) Int. Cl. G01C 21/26

(52) U.S. Cl. 701/201

(57) ABSTRACT

A method enables a user to quickly and easily specify a destination by selecting and modifying previous destinations stored in the navigation system. The method includes the steps of: creating a previous destination database by storing address information every time when a destination is set in a navigation system, selecting an input method which utilizes the address information in the previous destination database for specifying a new destination, displaying a list of previous destinations set in the previous destination database, selecting one of the destinations from the previous destination list; and selecting a part of address information of the selected destination and changing the selected part to create the new destination.

### FIELD OF THE INVENTION

This invention relates to an input method and apparatus for use in a navigation system, and more particularly, to a method and apparatus for specifying a destination by selecting and modifying previous destinations stored in the navigation system.

### BACKGROUND OF THE INVENTION

A navigation system performs travel guidance for enabling a user to easily and quickly reach the selected destination. A typical example is a vehicle navigation system where a navigation system is installed in a vehicle such as an automobile, motorcycle and the like. The present invention is not limited to a vehicle navigation system but is applicable to other types of navigation systems such as a PDA (Personal Data Assistant), a cellular phone, and other portable navigation devices. However, for the convenience of explanation, the following description is made mainly for the vehicle navigation system.

When a destination is set, the navigation system starts a route guidance function for guiding the user through a guided route from the start point to the destination. To determine the guided route to the destination, the navigation system calculates and determines an optimum route to the destination based on various parameters. During the route guidance, when the vehicle is within a predetermined distance of an intersection it is approaching, an intersection guidance diagram is displayed to inform the user of the road or direction that the user should take at the intersection. Such route guidance by the navigation system is also given by voice instructions.

FIGS. 1A-1H show an example of overall procedure and screen display involved in the navigation system. FIG. 1A shows an example of locator map screen of the navigation system typically used when the destination is not specified. The navigation system displays a street on which the vehicle (current vehicle position VP) is running on a map image and a name of the street.

FIGS. 1B-1E show an example of process for specifying a destination in the navigation system through a “Recent Route” input method. When selecting a “Destination” menu on a main menu screen of FIG. 1B, the navigation system displays a “Find Destination By” screen as shown in FIG. 1C for specifying a list of input methods for selecting the destination. This screen shows various methods for selecting the destination, for example “Address”, “Intersection”, “Point of Interest (POI)”, “Map Cursor”, “Recent Route”, “Address Book”, and “Today's Plan”.

In this example, the input method “Recent route” is used to display a predetermined number of destinations that have been used in the past to be selected as the current destination. When the “Recent route” method is chosen in FIG. 1C, the navigation system displays a list of recent destinations visited so that user can select the desired destination from the list shown in FIG. 1D. When an address is selected by the user, the navigation system displays a “Confirm Destination” screen such as shown in FIG. 1E. If the name and address on the screen shows the correct destination, the user enters an “OK to Proceed” key to proceed to the next procedure.

In FIG. 1F, the navigation system calculates and determines a route to the selected destination. Once the route to the destination is determined, the navigation system starts the route guidance as shown in FIG. 1G for guiding the user to the destination. Typically, the navigation system shows an intersection that is highlighted on the display to notify the user of the next turn and the direction of the turn. When the user approaches the destination within such a predetermined distance, the navigation system indicates that the destination is approaching as shown in FIG. 1H.

In the conventional “Recent Route” input method noted above, the user selects an address from the list of predetermined number of previous routes stored in the system. For easily searching the recent routes, the maximum number of recent routes in the list is limited to relatively small number such as ten (10). Every time the user inputs new destinations in the navigation system, the new destination is stored in the system. The oldest destination that exceeds the predetermined maximum number is removed.

For example, if the number of address to be stored in the system for “Recent Route” is ten, the eleventh input would cause the first input to be deleted from the system automatically. This creates some problems for the user when the user desires to go back to the destination that was visited 12th or 13th trips ago. The user will need to input the entire address again from the beginning using input methods such as “Address”. This would require the user to go through series of screens to enter the state, city, street, etc.

Furthermore, in the input method that lists previous destinations such as “Recent Routes” above, the user can not alter the address that is stored in the system. That is, if the user only wanted to change the address number of the same street of the recent route, the user would have to input the entire address again from the beginning using input method such as “Address”. This would require the user to go through series of keyboard screens to enter the city, street, address number, etc.

This process is shown in FIGS. 2A-2H. When selecting a “Destination” menu on a main menu screen of FIG. 2A, the navigation system displays an “Find Destination By” screen as shown in FIG. 2B for specifying a list of input methods for selecting the destination. In this example, the user selects the input method “Address” because the new destination is not exactly the same as those stored in the navigation system. Then, the navigation system displays a keyboard screen of FIG. 2C to prompts the user to specify the city name of the destination.

Based on the characters input by the user, the navigation system displays a list of city names as shown in FIG. 2D. When selecting one of the city names, the navigation system displays a keyboard screen of FIG. 2E to prompts the user to specify the street name of the destination. After specifying the street name, in FIG. 2F, the navigation system displays a numeric keyboard screen to prompts the user to specify the address number. After all these steps noted above, the navigation system confirms the destination in FIG. 2G and moves to the route guidance in FIG. 2H. In this manner, to input a new address takes a long time for entering names and numbers through several different keyboard screens.

There arises a situation where the user wants to go to a place which is located close to the place where the user has previously visited. In other case, the user wants to go to a place which is located on the same street of different house number from the place where the user has previously visited. In such a case, rather than newly inputting an entire address of a destination through a keyboard screen, for example, the destination can be set easily and quickly if a portion of the data of the previous destination can be modified.

Because the conventional navigation system does not allow the user to change the data of the recent route, and the maximum available number of recent route is very small, the conventional “Recent Route” method is not useful for such a situation. Further, when the user desires to go to a place similar to the previous destination, the user cannot alter the information in the system. The user has to input the entire information, which requires many steps of key operation as shown in FIG. 2A-2H. Thus, there is a need for a navigation system that can easily and quickly modified the information stored in the navigation system.

### SUMMARY OF THE INVENTION

It is, therefore, an object of the present invention to provide a navigation system which enables a user to easily and quickly set a new destination by modifying the destination information stored in the navigation system.

It is another object of the present invention to provide a method and apparatus for a navigation system that provides an intelligent user interface so that a user can save steps of input process for selecting a destination.

In the present invention, the navigation system is provided with an input method which selects and modify one of previous destinations stored in the previous destination database in the navigation system. The previous destination database of the navigation system stores all of the destinations that have been set by users of the navigation system. The user is then able to choose the previous destination from the list to modify the address.

When a destination is selected from the list, the navigation system displays a confirmation screen in which a user can go on with the selection or alter any part of the destination information. When the user needs to alter the information, the user can select one or more selection keys indicating “State”, “City”, “Street” and “Number” for changing the address data of the previous destination. Each change of the information would cause the navigation system to query with the database so that a unique address is displayed for the user to confirm the address.

More specifically, the method of the present invention includes the steps of: storing the destination information, selecting the “Previous Routes” input method, displaying a list of previous destinations, selecting a destination, modifying the destination information if necessary, confirming the updated destination, and calculating route to the user's destination from a current position and guiding the user to reach the destination.

Another aspect of the present invention is a display apparatus for a navigation system. The display apparatus is configured by various means for achieving the display methods described above which utilizes the “Previous Destination” menu to provide the user with a selection to previous destinations stored in the navigation system so that it can be used as the current destination or its alteration thereof.

According to the present invention, the navigation method and apparatus provides a way for a user to easily and efficiently alter the destination address stored in the system. The user can alter any part of the destination dynamically using an intuitive interface including the selection keys “State”, “City” “Street” and “Number”. In other words, the user can recycle the address information in the previous destinations. Because the user does not need to input the entire address information over again, the user can save time in inputting the new information into the system.

### BRIEF DESCRIPTION OF THE DRAWINGS

FIGS. 1A-1H are schematic diagrams showing an example of process and screen display of a navigation system for specifying a destination through a recent route method, determining route to the destination, and guiding a user to the destination.

FIGS. 2A-2H are schematic diagrams showing an example of process and screen display of a navigation system for specifying a destination through an address input method, determining route to the destination, and guiding a user to the destination.

FIGS. 3A-3H are schematic diagrams showing an example of process and screen display of a navigation system for specifying a destination through a previous destination method of the present invention, determining route to the destination, and guiding a user to the destination.

FIG. 4 is a block diagram showing an example of structure in the vehicle navigation system for implementing the previous destination method of the present invention.

FIGS. 5A-5H are schematic diagrams showing an example of process and screen display of a navigation system for specifying a destination through a previous destination method of the present invention including a step of selecting a sorting method of previous destinations.

FIG. 6 is a flow chart showing a basic operational process of the input method of the present invention for selecting and modifying the address data of the previous destination in the navigation system.

### DETAILED DESCRIPTION OF THE INVENTION

The present invention will be described in detail with reference to the accompanying drawings. There arises a case where the user wants to go to a place which is located close to the place where the user has previously visited. In other case, the user wants to go to a place which is located on the same street with different house number where the user has previously visited. In such a case, rather than newly inputting an entire address of a destination through layers of keyboard screen, for example, the destination can be set easily and quickly if the address data of the previous destination can be modified.

The navigation system in the present invention is designed so that a new destination can be set in a navigation system easily and quickly by altering the previous destination information stored in the navigation system. The present invention is advantageously applicable to the situation where the user has visited to a particular location before and needs to alter, for example, the house number (address number) of the previous destination.

In order to achieve this objective, the navigation system stores all of the destinations that the user has set in the navigation system so far and provides means for altering the stored information dynamically by the user. Therefore, the user does not need to input an entire address of a new destination. Since the user does not need to input the entire address into the navigation system, the user is able to avoid the burdensome steps of inputting the address information.

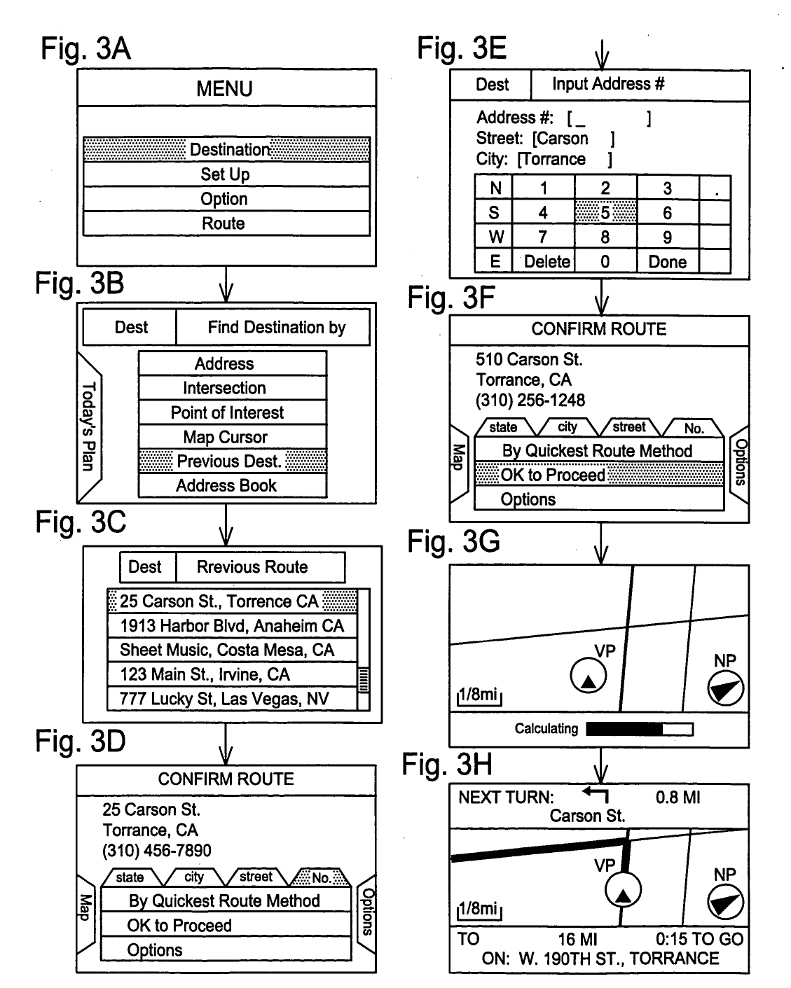

FIGS. 3A-3H are schematic diagrams showing an example of process and screen display of the navigation system for specifying a destination through a previous destination method of the present invention, determining route to the destination, and guiding the user to the destination. In the present invention, the “Previous Destination” input method is used for setting a new destination. In the process, first, on the main menu screen of FIG. 3A, the user selects “Destination” key to move to a list of input methods for selecting a destination.

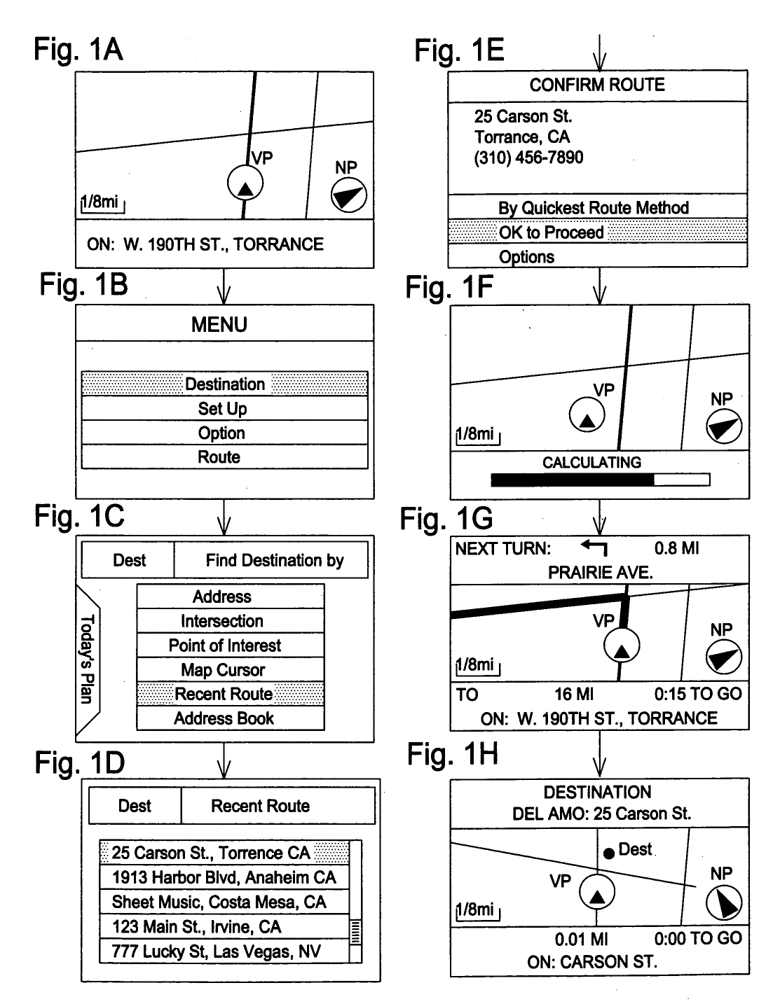

Then, the navigation system displays a list of input methods for selecting a destination which includes a “Recent route” input method of the present invention as shown in FIG. 3B. Other input-methods are the same as those shown in the example of FIG. 1C. The user selects the “Previous Destination” input method in FIG. 3B.

Then, the navigation system displays a list of previous destinations as shown in FIG. 3C. The list of previous destinations is stored in a previous destination database of the navigation system and is retrieved when the “Previous Destination” method is selected as noted above. The conventional “Recent route” function noted above with reference to FIGS. 1C-1E can store a small number of previous destinations such as ten (10). However, the navigation system of the present invention is designed to store all of the previous destinations, i.e, virtually unlimited number of destinations in the previous destination databases. Preferably, the destinations set in the navigation system but not visited are also stored in the previous destination database.

The user can choose from the list of destinations visited in the past to use for producing a new destination by partially changing the address. Suppose the user knows that the place he wants to visit is located close to the place where he has visited before. For example, the place he wants to visit is on “Carson Street” in the city of Torrance and he has visited “25 Carson Street” in the same city before. If the user knows the address (house) number, he changes the number “25” to that new number. Even if he does not know the exact number, but only knows that the house number is several hundred, it may be a good idea to specify the new destination such as “510 Carson Street” because in many cases, when he comes to the neighborhood, he knows the actual location of the destination.

Thus, in the above example, the user selects “25 Carson Street, Torrance Calif.” in FIG. 3C by, for example, scrolling the list of previous destinations. When a particular address is chosen from the list, the navigation system displays a destination confirmation screen such as shown in FIG. 3D. This screen shows the selected previous destination and several possible choices. If the user wants to visit the place of the address on the screen, he selects “OK to Proceed” for calculating a route to the address. However, in this example, he wants to create a new destination by changing the street number of the address on the screen.

Thus, for easily changing the desired portion of the address of the previous destination, the screen of FIG. 3D includes selection keys for a user to select an item of the address of the previous destination to modify. The example of selection keys includes “State”, “City”, “Street” and “Number”. For example, when the “State” key is selected, the user can change the name of the state, when the “City” is selected, the user can change the name of the city, when the “street” is selected, the user can alter the street name to another street, and when the “Number” key is selected, the user can change the address (house) number of the street.

In this example, since the user wants to change the address number from “25” to “510”, the user selects the “Number” key in FIG. 3D. Then, the navigation system displays a screen of FIG. 3E for a user to specify the address number on the “Carson Street”. Through the numeric keyboard of FIG. 3E, the user changes the address number from “25” to “510”. In FIG. 3F, since the address shown on the screen now is the desired destination, the user selects the “OK to Proceed” key. The navigation system calculates a route to the new destination in FIG. 3G and starts the route guidance to the destination as shown in FIG. 3H.

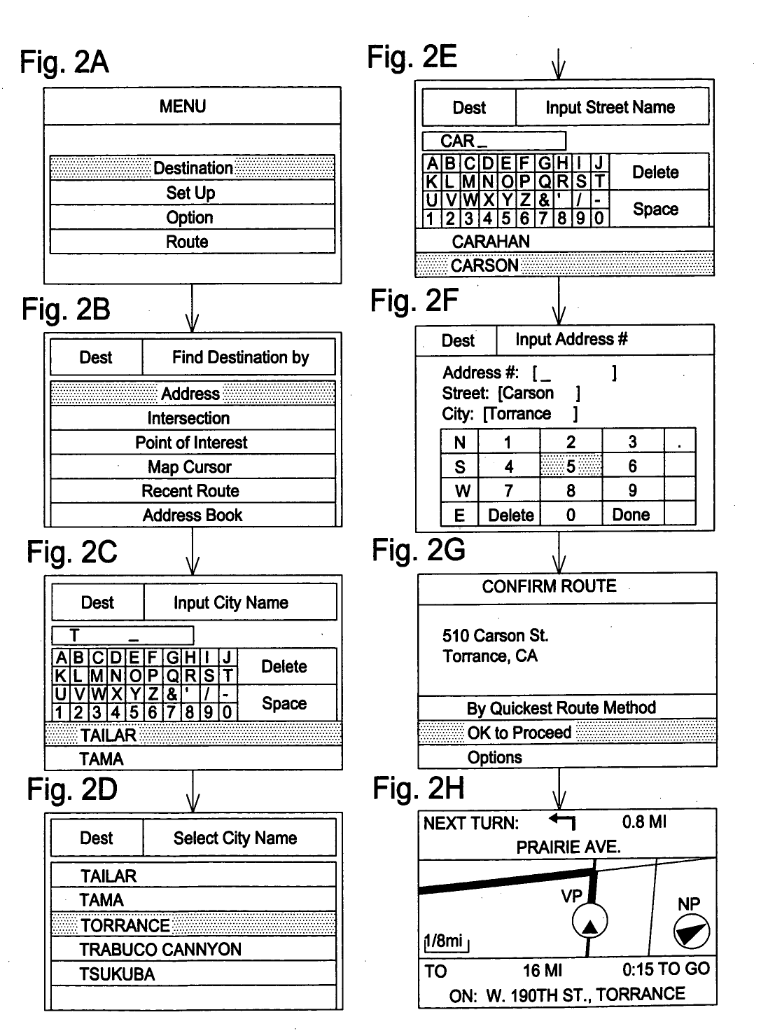

In the conventional technology, even when the address of the new destination is similar to that of the previous destination, the user has to input the entire address over again. Such a process requires many steps of key operations for specifying a city name, street name, and an address number as described with reference to FIGS. 2A-2H. In the present invention, by allowing the user to select and modify the information stored in the navigation system, the user is able to avoid the burden of inputting the information in the navigation system.

Typical example of modifying previous destination information in the present invention is to change the address number as noted above. However, with use of the other selection keys “State”, “City”, “Street” shown in FIGS. 3D and 3F, the present invention also allows the user to create a new destination while making use of the address data of the previous destination. Once the system finds a unique destination based on the information specified by the user, the navigation system would switch to the confirmation screen such as shown in FIG. 3F.

When the “OK to proceed” key is pressed, the navigation system calculates the route to the new destination as shown in FIG. 3G. Typically, at this time, the information concerning the new destination is stored in the previous destination database of the navigation system. Then, the navigation system starts the route guidance to the destination. The selection keys “State”, “City”, “Street” and “Number” in the above example can be replaced with other types of keys or displays such as pop-up screens, selection boxes, symbols, marks or icons, etc.

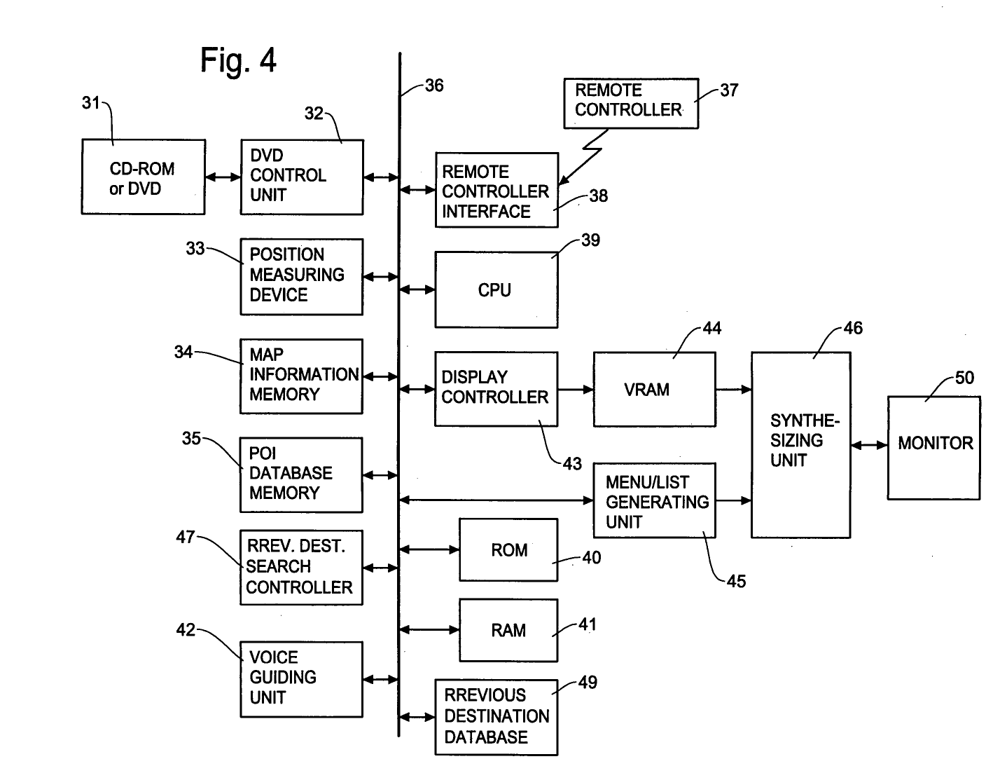

FIG. 4 shows a structure of a vehicle navigation system for implementing the present invention. While the vehicle navigation system is explained for an illustration purpose, the present invention can be applied to other types of navigation systems such as portable handheld navigation device utilizing a GPS and a PDA.

In the block diagram of FIG. 4, the navigation system includes a map storage medium 31 such as a CD-ROM, DVD, hard disc or other means (hereafter “DVD”) for storing map information. Alternatively, such map data can be provided to the user's navigation system from a remote navigation server through a communication network such as an Internet. The navigation system includes a DVD control unit 32 for a controlling an operation for reading the map information from the DVD, a position measuring device 33 for measuring the present vehicle position or user position. For example, the position measuring device 33 has a vehicle speed sensor for detecting a moving distance, a gyroscope for detecting a moving direction, a microprocessor for calculating a position, a GPS (Global Positioning System) receiver for receiving signals from GPS satellite, and etc.

The block diagram of FIG. 4 further includes a map information memory 34 for storing the map information which is read from the DVD 31, a POI database memory 35 for storing information on points of interest (POI) which is read out from the DVD 31, a remote controller 37 for executing a menu selection operation, an enlarge/reduce operation, a destination input operation, etc. and a remote controller interface 38.

Although a remote controller is a typical example for selecting menus, executing selected functions and etc., the navigation system includes various other input methods to achieve the same and similar operations done through the remote controller. For example, the navigation system includes hard keys and a joystick on a head unit of the navigation system mounted on a dash board, tough screen of the display panel, and voice communication means.

The navigation system further includes a bus 36 for interfacing the above units in the system, a processor (CPU) 39 for controlling an overall operation of the navigation system, a ROM 40 for storing various control programs such as a route search program and a map matching program necessary for navigation control, a RAM 41 for storing a processing result such as a guide route, a voice interface and guiding unit 42 for voice communication interface and spoken instructions, a display controller 43 for generating map image (a map guide image and an arrow guide image) on the basis of the map information, a VRAM 44 for storing images generated by the display controller 43, a menu/list generating unit 45 for generating menu image/various list images, a synthesizing unit 46, a previous destination search controller 47, a previous destination database 49, and a monitor (display) 50.

The previous destination search controller 47 and the previous destination database 49 play a major role in the present invention. The previous destination search controller 47 can be implemented by the CPU 39 or by a separate microprocessor. The previous destination search controller 47 controls an overall operation of storing the information on the destinations in the previous destination database 49, retrieving the previous destination data from the database 49, displaying the unique screens involved in the previous destination operations, etc. The previous destination database 49 can be of any non-volatile memory such as a flash memory, a hard disc, etc. The previous destination search controller 47 allows the user to select and change the address information (state, city name, street name, address number) of the previous destination.

When the user inputs the destination information, all of the necessary information during the destination input process is stored in the previous destination database 49. All of the destination data selected by the user are stored in the previous destination database 49 regardless of whether the user actually visited the destinations. This information can be accessed by choosing the “Previous Destination” input method on the destination selection screen.

When the address data of the previous destination is selected by the user, the recent route search controller 47 provides selection keys so that the user can select one or more items of the address that he wants to change. The recent route search controller 47 also provides means for the user to select a method of sorting the previous destination data for quickly searching the previous destination when the database 49 is large. The recent route search controller 47 receives new address data of the destination information produced by the user by modifying the address data of the previous destination. The navigation system finds an appropriate route to the destination and starts the route guidance to the destination.

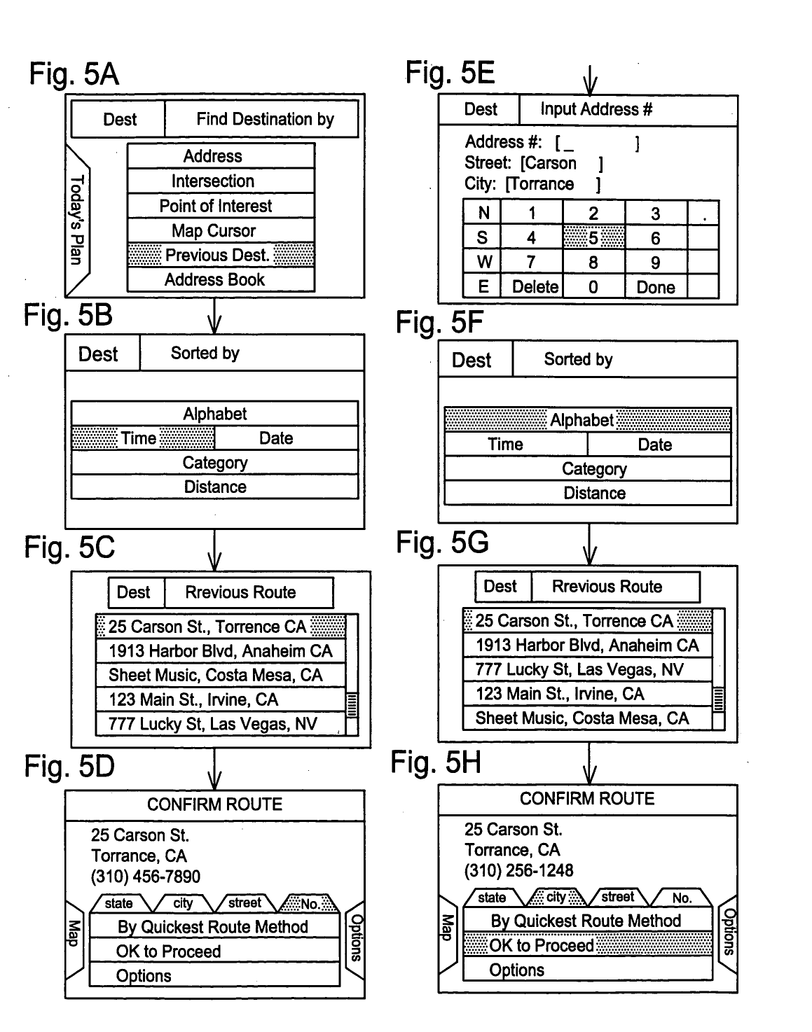

FIGS. 5A-5H are schematic diagrams showing another example of process and screen display of the navigation system for specifying a destination through the previous destination method of the present invention which includes a step of selecting a sorting method of the previous destinations. As noted above, there is no limit to the number of previous destinations that can be stored in the previous destination database 49. Thus, when the number of previous destinations in the database 49 is large, it may be difficult to find a desired previous destination by scrolling the entire list of previous destinations. Thus, the example of FIGS. 5A-5H provides a step of selecting a sorting method for listing the previous destinations on the screen.

In FIG. 5A, the navigation system displays a list of input methods for selecting a destination which includes the “Recent route” input method of the present invention. The user selects the “Previous Destination” input method on the screen of FIG. 5A. Then, the navigation system displays a list of sorting methods for specifying a listing order of the previous destinations as shown in FIG. 5B. In this example, the list of sorting method includes “Alphabet” for listing the previous destinations in an alphabetical order, “Time” for listing the previous destinations in the order of time, “Date” for specifying a particular date, month or year, “Category” for specifying a particular type of destination such as restaurant, store, etc., and “Distance” for listing the previous destinations in the order of distance from the user's current position.

When selecting “Time”, the navigation system displays a list of the previous destinations in the order of time as shown in FIG. 5C, from the oldest to the newest, or vice versa. The user selects one of the recent routes “25 Carson St., Torrance, Calif.” from the list to recycle the data thereof. Thus, the processes of FIGS. 5D and 5E are basically the same as those shown in FIGS. 3D and 3D where the user changes the address number from “25” to “510” with use of the selection key “Number”.

FIG. 5F shows a case where the user selects the “Alphabet” sorting method. The navigation system displays a list of recent routes in an alphabetical order in FIG. 5G. The user selects one of the recent routes from the list to modify the part of destination data. In the example of FIG. 5H, the user changes the city name through the selection key “City”. For example, in the case where a particular place that the user wants to visit is located on the same street of the previous destination in the next city, the user can set the new destination quickly by changing the city name.

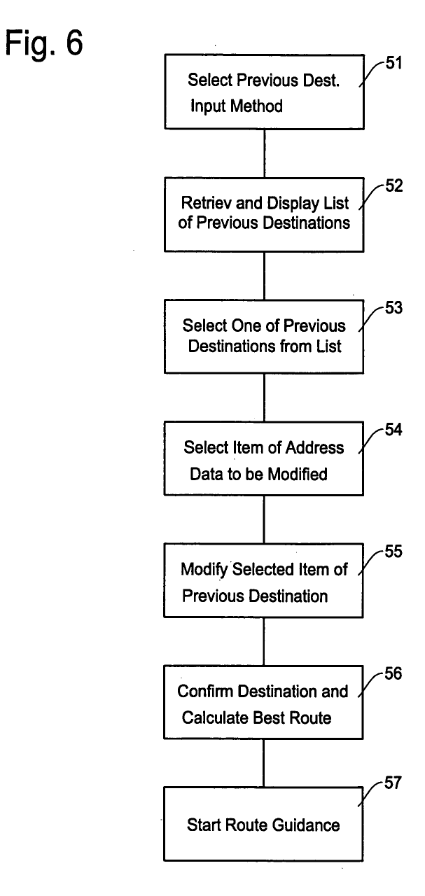

FIG. 6 is a flow chart showing a basic operational process of the present invention for changing the previous destination data stored in the navigation system. At step 51, from the list of input method for setting the destination, the user selects the “Previous Destination” method. In step 52, the navigation system retrieves the data from the recent route database and displays a list of previous destinations. Prior to the step 52, it is possible that the navigation system provides a list of sorting method such as shown in FIG. 5B to prompt the user to select one of the sorting methods.

At step 53, the user selects one of the previous destinations from the list produced in step 52. Then, at step 54, the user selects the item of the address data of the previous destination that he wants to modify. For this purpose, the navigation system provides the selection keys on the screen for the user to select an item of the address of the previous destination to modify. In the above example shown in FIGS. 3A-3H and 5A-5H, the selection keys include “State”, “City”, “Street” and “Number”.

At step 55, the user changes the data of the selected item of the previous destination, such as address number. The steps 54 and 55 may be repeated if the user desires to change two or more items of the address of the previous destination. When the new destination is set, in step 56, the navigation system confirms the new destination and calculates the route to the destination. Then, the navigation system starts the route guidance to the destination in step 57.

As has been described, according to the present invention, the navigation method and apparatus provides a way for a user to easily and efficiently alter the destination address stored in the system. The user can alter any part of the destination dynamically using an intuitive interface including the selection keys “State”, “City” “Street” and “Number”. In other words, the user can recycle the address information in the previous destinations. Because the user does not need to input the entire address information over again, the user can save time in inputting the new information into the system.

Although the invention is described herein with reference to the preferred embodiment, one skilled in the art will readily appreciate that various modifications and variations may be made with out departing from the spirit and scope of the present invention. Such modifications and variations are considered to be within the purview and scope of the appended claims and their equivalents.

What is claimed is:

1. A method for specifying a new destination in a navigation system, comprising the following steps of:
memorizing address information of in a memory to create a previous destination database every time when a destination is set in a navigation system;
selecting the address information in the previous destination database for specifying a new destination;
displaying a list of previous destinations retrieved from the previous destination database;
selecting one of the destinations from the previous destination list; and
selecting a part of address information of the selected destination and changing the selected part to create the new destination.

2. A method as defined in claim 1, wherein said step of memorizing address information includes a step of collecting address information of the destination set by a user in the previous destination database without regard to whether or not the user actually visited the destination.

3. A method as defined in claim 1, wherein said step of selecting a part of the address information includes a step of displaying one or more selection keys for the user to select the part of the address information of the previous destination desired to be modified.

4. A method as defined in claim 3, wherein said selection key includes at least a first key for changing an address number of the selected previous destination.

5. A method as defined in claim 3, wherein said selection key includes at least a first key for changing an address number of the selected previous destination and a second key for changing a street name of the selected previous destination.

6. A method as defined in claim 5, wherein said selection key further includes a third key for changing a city name of the selected previous destination.

7. A method as defined in claim 1, prior to said step of displaying the list of previous destinations, further comprising the steps of:
displaying a list of sorting methods for sorting the previous destinations retrieved from the previous destination database; and
selecting one of the sorting methods for specifying an order of listing the previous destinations from the previous destination database.

8. A method as defined in claim 7, wherein said list of sorting methods includes at least a time method for listing the previous destinations in the order of time and an alphabetical method for listing the previous destinations in the alphabetical order.

9. A method as defined in claim 8, wherein said list of sorting methods further includes a category method for listing the previous destinations sorted by the type of destinations.

10. A method as defined in claim 1, further comprising a step of confirming the new destination and calculating a route to the new destination.

11. An apparatus for specifying a new destination in a navigation system, comprising:
means for memorizing address information to create a previous destination database every time when a destination is set in a navigation system;
means for selecting the address information in the previous destination database for specifying a new destination;
means for displaying a list of previous destinations retrieved from the previous destination database;
means for selecting one of the destinations from the previous destination list; and
means for selecting a part of address information of the selected destination and changing the selected part to create the new destination.

12. An apparatus as defined in claim 11, wherein said means for memorizing the address information includes means for collecting address information of the destination set by a user in the previous destination database without regard to whether or not the user actually visited the destination.

13. An apparatus as defined in claim 11, wherein said means for selecting a part of the address information includes means for displaying one or more selection keys for the user to select the part of the address information of the previous destination desired to be modified.

14. An apparatus as defined in claim 13, wherein said selection key includes at least a first key for changing an address number of the selected previous destination.

15. An apparatus as defined in claim 13, wherein said selection key includes at least a first key for changing an address number of the selected previous destination and a second key for changing a street name of the selected previous destination.

16. An apparatus as defined in claim 15, wherein said selection key further includes a third key for changing a city name of the selected previous destination.

17. An apparatus as defined in claim 11, prior to displaying the list of previous destinations, further comprising:
means for displaying a list of sorting methods for sorting the previous destinations retrieved from the previous destination database; and
means for selecting one of the sorting methods for specifying an order of listing the previous destinations from the previous destination database.

18. An apparatus as defined in claim 17, wherein said list of sorting methods includes at least a time method for listing the previous destinations in the order of time and an alphabetical method for listing the previous destinations in the alphabetical order.

19. An apparatus as defined in claim 18, wherein said list of sorting methods further includes a category method for listing the previous destinations sorted by the type of destinations.

20. An apparatus as defined in claim 11, further comprising means for confirming the new destination and calculating a route to the new destination.
